(19) United States
(12) Patent Application Publication
(10) Pub. No.: US 2025/0104904 A1
(43) Pub. Date: Mar. 27, 2025

(54) INDUCTOR CIRCUITRY

(71) Applicant: XILINX, INC., San Jose, CA (US)

(72) Inventors: Jing JING, San Jose, CA (US); Shuxian WU, San Jose, CA (US)

(73) Assignee: XILINX, INC., San Jose, CA (US)

(21) Appl. No.: 18/373,916

(22) Filed: Sep. 27, 2023

(51) Int. Cl. H01F 27/28

(52) U.S. Cl. CPC H01F 27/2885

(57) ABSTRACT

Examples herein describe inductor circuitry including an inductor coil having a helical shape. The inductor coil includes a first turn and a second turn which are disposed within an isolation wall. The isolation wall extends above the inductor coil and below the inductor coil. The inductor circuitry includes an inductor leg which extends through an aperture of the isolation wall. The inductor leg includes a first portion which is disposed within the isolation wall and a second portion that is disposed outside of the isolation wall.

### TECHNICAL FIELD

Examples of the present disclosure generally relate to integrated circuit (IC) components, and more specifically, to inductor circuitry.

### BACKGROUND

Although inductors are ubiquitous elements in circuit design, designing inductors for use in integrated circuits (ICs) involves a variety of practical considerations and challenges. For example, an area or footprint of the inductor should be minimized due to the compact chip size of the IC. In another example, potential interference with and from other circuit components should be evaluated in order to avoid unintended/diminished performance of the IC.

### SUMMARY

Inductor circuitry is described which can be used as a standalone inductor device or as part of an integrated circuit (IC) such as an oscillator. The inductor circuitry includes a helically shaped inductor coil having a first turn and a second turn. The first tum and the second turn are disposed within an isolation wall which extends above and below the inductor coil. In an example, the isolation wall is configured to physically separate the first turn and the second turn from other components/devices which could adversely affect the inductor circuitry.

In some examples, the inductor circuitry includes a pattern ground shielding (PGS) which is disposed below the inductor coil to mitigate electromagnetic interference. The PGS can include electrical conductors (e.g., lines or wires) oriented in directions which are perpendicular to a direction of current flow through the inductor coil. For instance, the electrical conductors act as a shield that protects the inductor from lossy substrates and the circuitry from external electromagnetic radiation.

In one example, the inductor circuitry includes inductor arms which are partially disposed within (inside of) the isolation wall. The inductor arms can extend through apertures in the isolation wall such that the inductor arms are also partially disposed outside of the isolation wall. For example, portions of the inductor arms which are disposed outside of the isolation wall are capable of aligning with (or connecting to) additional circuitry such as bus lines of a capacitor array.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings Illustrate only typical example implementations and are therefore not to be considered limiting of its scope.

FIG. 1 illustrates inductor circuitry, according to an example.

FIG. 2 illustrates a first example of a layer of an inductor coil, according to an example.

FIG. 3 illustrates a second example of a layer of an inductor coil, according to an example.

FIG. 4 depicts a diagram illustrating an isolation wall of inductor circuitry, according to an example.

FIG. 5 depicts a diagram illustrating inductor legs of inductor circuitry, according to an example.

FIG. 6 illustrates a representation of example layers of inductor circuitry, according to an example.

FIG. 7 illustrates a representation of a first pattern ground shielding (PGS) design and a second PGS design, according to an example.

FIG. 8 depicts a diagram illustrating a differential inductor, according to an example.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Designing inductors for use in integrated circuits (ICs) is challenging because ICs typically include a relatively large number of components/devices within a relatively small area or footprint. This high density of components/devices contributes to environmental effects (e.g., crosstalk, parasitic effects, etc.) which can adversely affect an inductor quality factor (Q), alter an inductance value from an intended/designed value, cause shifts in frequencies from an intended/designed frequency, and so forth. Additionally, the environmental effects are difficult to predict because of the uncertainty of current return paths within the wide variety of existing IC configurations and the unpredictability of future configurations.

Examples herein describe inductor circuitry which is implementable in variety of different circuit components (e.g., circuit subcomponents) and integrated circuits (ICs) using both isolation and shielding to mitigate environmental effects. In various embodiments, the inductor circuitry includes multiple layers which can be deposited on a substrate (e.g., a silicon wafer) layer-by-layer starting from an initial layer (e.g., a silicon dioxide layer) and ending with a top layer (e.g., a top metal layer). In some embodiments, layers of the inductor circuitry are referenced by a material type and an order number (e.g., M0, M1, . . . , Mn) such that Mn may designate metal (e.g., aluminum, copper, etc.) layer number “n.” Notably, the inductor circuitry can be manufactured using other processes in addition or alternative to depositing layers such as etching, doping, masking, etc.

In some examples, the inductor circuitry includes an inductor coil having a helical shape which may visually resemble a “figure eight.” The inductor coil has a relatively small footprint (e.g., for implementation in ICs) which is constrained in one or more dimensions (e.g., x-dimensions and y-dimensions). In an embodiment, the inductor coil includes a first turn (e.g., an upper turn), a second turn (e.g., a lower turn), and an area of partially overlapping layers disposed between the first turn and the second turn. For example, the first turn and the second turn are connected in series via the area of the partially overlapping layers (e.g., using a layer to connect to the first turn and a metal layer transition to disconnect the second turn).

In some embodiments, the inductor circuitry includes an isolation wall manufactured using all available layers (or many available layers) of the inductor circuitry (e.g., M0, M1, . . . , Mn). For example, the isolation wall extends from an oxide diffusion (OD) layer to a top metal layer of the inductor circuitry. In an embodiment, the first turn and the second turn of the inductor coil are disposed within the isolation wall, and the isolation wall extends above and below the inductor coil (e.g., to provide a predetermined current return path).

In some examples, the inductor circuitry includes a first inductor leg and a second inductor leg which each extend laterally out from the area of the partially overlapping layers and through apertures in the isolation wall. In an example, the first inductor leg includes a first medial portion which extends at an angle (e.g., in a first direction) relative to the area of the partially overlapping layers and the second inductor leg includes a second medial portion which extends at the angle (e.g., in a second direction) relative to the area of the partially overlapping layers. The first medial portion is disposed within the isolation wall and the second medial portion is also disposed within the isolation wall.

In one embodiment, the first inductor leg includes a first lateral portion which extends out from the isolation wall and is disposed outside of the isolation wall. In another embodiment, the second inductor leg includes a second lateral portion which extends out from the isolation wall and is disposed outside of the isolation wall. In an example, the first lateral portion and the second lateral portion are configured to connect to bus lines of a capacitor array (e.g., a finger capacitor array) to form an LC tank circuit.

In various embodiments, the inductor circuitry also includes a pattern ground shielding (PGS) implemented using a lower layer of the inductor circuitry (e.g., M0). For example, the PGS is disposed below the inductor coil. In some examples, the PGS includes electrical conductors that are oriented perpendicularly to a direction of current flow through the inductor coil. These electrical conductors shield the inductor coil from external electromagnetic radiation.

In some embodiments, the PGS and the isolation wall in combination are effective to overcome the challenges presented by the high density of components/devices in ICs. This combination shields the inductor circuitry from below and isolates the inductor coil from all sides such that the environmental effects are mitigated. Additionally, in an example, by extending the first inductor leg and the second inductor leg through the apertures in the isolation wall to interface with the bus lines of the capacitor array, nearly all of the inductor circuitry is protected by the PGS and the isolation wall without adversely affecting implementation of the LC tank circuit.

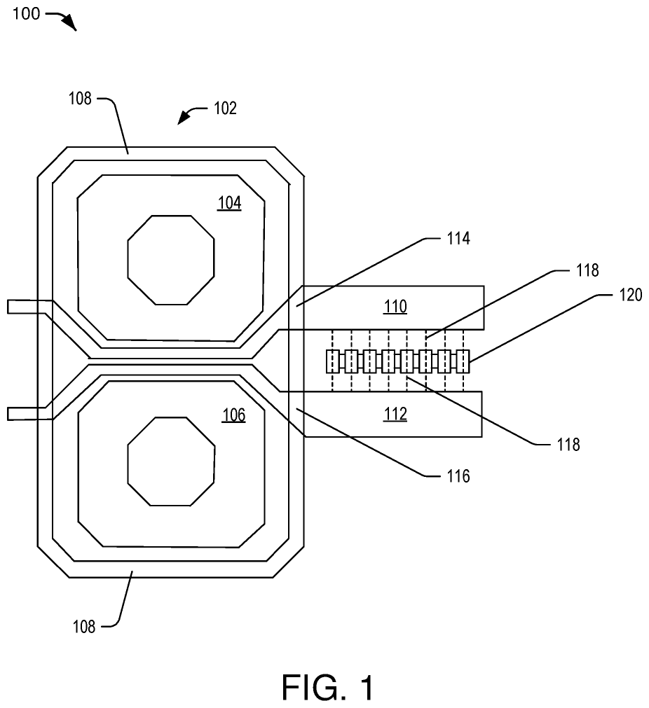

FIG. 1 illustrates inductor circuitry 100, according to an example. The inductor circuitry 100 is illustrated to include an inductor coil 102. In some examples, the inductor coil 102 is a differential inductor having a helical shape which is Illustrated to resemble a glyph of the number “eight” or a “figure eight” in the inductor circuitry 100 depicted in FIG. 1. However, in other examples, the inductor coil 102 has other shapes which include, but are not limited to, substantially symmetric shapes and at least partially asymmetric shapes.

The inductor coil 102 includes a first turn 104 (e.g., an upper turn) and a second turn 106 (e.g., a lower turn). In various embodiments, the first tum 104 and the second turn 106 are manufactured by layer deposition of electrically conductive materials (e.g., copper, copper alloy, aluminum, aluminum alloy, etc.). In some embodiments, the first tum 104 and the second turn 106 are manufactured using etching techniques, masking techniques, additive manufacturing techniques, and so forth.

In an example, the first turn 104 and the second turn 106 have similar shapes and dimensions and are symmetric relative to a transverse plane between the first turn 104 and the second turn 106 (e.g., the first turn 104 is a “mirror image” of the second tum 106). In another example, the first turn 104 and the second turn 106 have at least partially asymmetric shapes relative to the transverse plane (or another plane). Notably, the inductor coil 102 has a relatively small area or footprint within the inductor circuitry 100 which is constrained in one or more dimensions (e.g., both x-dimensions and y-dimensions).

The inductor circuitry 100 also includes an isolation wall 108 which is disposed around the first turn 104 and the second turn 106 of the inductor coil 102. For example, the isolation wall 108 extends above and below the inductor coil 102. In one example, the isolation wall 108 is fabricated or manufactured using all available layers of the inductor circuitry 100 (e.g., full layer deck) and extends from an oxide diffusion (OD) layer to a top metal layer of the inductor circuitry 100.

For instance, the isolation wall 108 is configured to physically isolate the inductor coil 102 (e.g., the first turn 104 and the second turn 106) from external interference caused by other devices/components such as by mitigating coupling/interference from neighboring or adjacent channels. In an example, the isolation wall 108 is also configured to electrically isolate some portions of the inductor circuitry 100 from the other devices/components. In this example, the isolation wall 108 prevents crosstalk between conductive portions of the inductor circuitry 100 and conductive portions of the other devices/components and also mitigates parasitic capacitance between the conductive portions of the inductor circuitry 100 and the conductive portions of the other devices/components.

A first inductor leg 110 and a second inductor leg 112 of the inductor circuitry 100 partially extend outside of the isolation wall 108. In one example, the first inductor leg 110 extends through a first aperture 114 in the isolation wall 108 and the second inductor leg 112 extends through a second aperture 116 in the isolation wall 108. As shown in FIG. 1, a portion of the first inductor leg 110 disposed outside of the isolation wall 108 interfaces with bus lines 118 of a capacitor array 120 (e.g., a finger capacitor array) and a portion of the second inductor leg 112 disposed outside of the isolation wall 108 also interfaces with the bus lines 118 of the capacitor array 120. For example, the capacitor array 120 is disposed between the first inductor leg 110 and the second inductor leg 112. In some examples, the first inductor leg 110 and the second inductor leg 112 are configured to align with a center of the bus lines 118 of the capacitor array 120 to reduce routing resistance and improve performance of a corresponding LC tank circuit. In various embodiments, the inductor circuitry 100 and/or the inductor coil 102 are implementable in a variety of different circuits including ICs such as voltage controlled oscillator (VCO) circuits, digitally controlled oscillator (DCO) circuits, phase locked loop (PLL) circuits, etc.

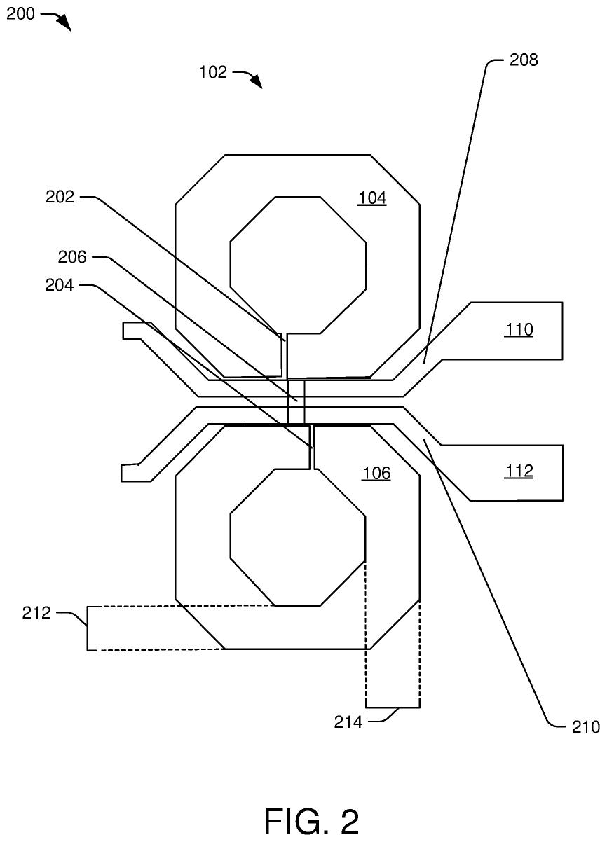

FIG. 2 illustrates a first example 200 of a layer of an inductor coil 102, according to an example. In one example, the layer of the inductor coil 102 included in the first example 200 is an M12 layer or a twelfth metal layer of the inductor circuitry 100. In some embodiments, eleven additional metal layers of the inductor circuitry 100 are deposited below the M12 layer, and additional layers of the inductor circuitry 100 (e.g., conductive layers, dielectric layers, etc.) can be deposited or fabricated above the M12 layer. In an example, the first turn 104 includes an aperture 202 (e.g., an M12 cut) which may or may not extend into layers of the inductor circuitry 100 that are above/below the M12 layer. For example, the second turn 106 is illustrated as including an aperture 204 (e.g., an M12 cut). Notably, the aperture 204 may or may not extend into layers of the inductor circuitry 100 that are above or below the M12 layer. Although the layer of the inductor coil 102 included in the first example 200 is described as an M12 layer, it is to be appreciated that the layer of the inductor coil 102 included in the first example 200 is can be implemented as various layers of the inductor circuitry 100 such as an M10 layer, an M11 layer, an M13 layer, an M14 layer, etc.

In an example, an area of partially overlapping layers 206 (e.g., partially overlapping metals) of the inductor coil 102 is disposed between the first turn 104 and the second turn 106. For instance, partially overlapping metals of the area of the partially overlapping layers 206 are configured to achieve a particular inductance (e.g., about 270 pH) of the inductor coil 102 and minimize parasitic capacitance within the inductor circuitry 100. Since parasitic capacitance can be caused by electric fields which are induced between overlapping conductive layers (e.g., metal layers) of the inductor circuitry 100, partially overlapping the metals of the area of the partially overlapping layers 206 reduces an effective area of overlap relative to fully overlapping the metals. This reduced overlapping area directly corresponds to a decrease in parasitic capacitance which may result in improved immunity to noise within the inductor circuitry 100.

In one embodiment, routing techniques are utilized to manufacture the area of the partially overlapping layers 206 by partially overlapping metals between the first turn 104 and the second turn 106 in order to achieve the particular inductance and minimize the parasitic capacitance. Examples of routing techniques which may be used to manufacture the area of the partially overlapping layers 206 include, but are not limited to, non-Manhattan routing, dummy fills, stripping and slotting, interlayer via staggering, etc. In an embodiment, for example, the inductor circuitry 100 is capable of achieving an example quality factor (Q) of greater than 10 at an example frequency of about 16 GHz.

In IC design and manufacturing, active layers generally include active components (e.g., semiconductors, diodes, transistors, etc.) for controlling/amplifying electrical signals while passive layers generally include passive components (e.g., resistors, capacitors, inductors, etc.) for routing or connecting active components. In some example embodiments, the first turn 104 is manufactured/constructed using an active/passive layer, and the second turn 106 is manufactured/constructed using two stacked metal layers (e.g., to reduce parasitic resistance by increasing a cross-sectional area for current flow, reducing current crowding, lowering sheet resistance, etc.). However, in other embodiments, the first turn 104 and the second turn 106 are manufactured/constructed using additional layers or fewer layers. In one example, in order to connect the first turn 104 and the second tum 106 in series and form a two-turn inductor, techniques are employed utilizing a single metal layer transition to disconnect the second tum 106 and a “dangling” layer (e.g., a layer which is not fully connected to other layers of the inductor circuitry 100) to connect to the first turn 104. In other examples, however, the first turn 104 and the second turn 106 are connected in series using variations of the one example described above and/or different manufacturing techniques.

In some examples, a first portion 208 of the first inductor leg 110 extends at an acute angle (e.g., about 45 degrees) in a first direction relative to the area of the partially overlapping layers 206 and a second portion 210 of the second inductor leg 112 extends at the acute angle in a second direction relative to the area of the partially overlapping layers 206. For example, the acute angle is configured to orient the first inductor leg 110 and the second inductor leg 112 relative to the capacitor array 120. In some embodiments, a width of the inductor coil 102 is configured to prevent non-uniform current density distributions within the inductor coil 102, e.g., by increasing the width of the inductor coil 102. In an example, the width of the inductor coil 102 is a variable width such that some portions of the inductor coil 102 have a first width 212 while other portions of the inductor coil 102 have a second width 214. In this example, the variable width of the inductor coil 102 is configured to mitigate/minimize parasitic capacitance within the inductor circuitry 100 e.g., by increasing the width of the inductor coil 102 where this is feasible or practical. For instance, increasing the width of the inductor coil 102 increases the cross-sectional area, decreases resistance, decreases current density, lowers voltage drops, etc.

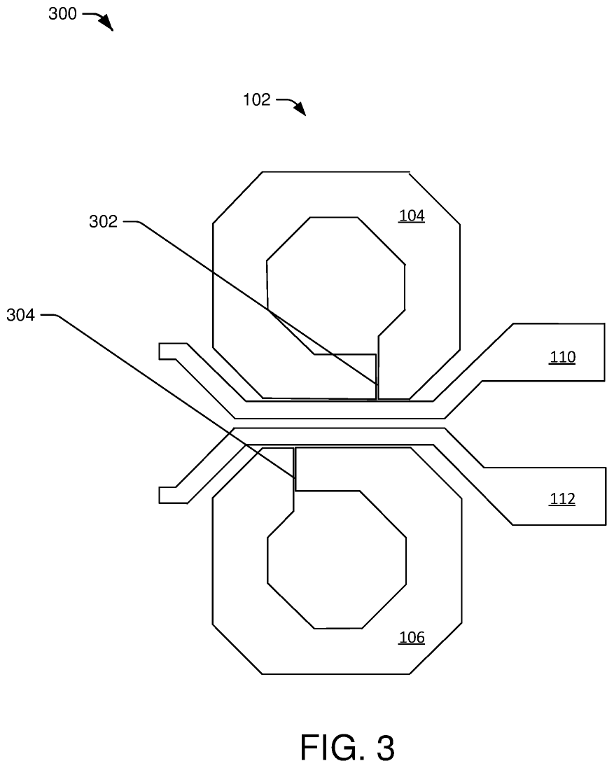

FIG. 3 illustrates a second example 300 of a layer of an inductor coil 102. according to an example. In an example, the layer of the inductor coil 102 included in the second example 300 is an M13 layer or a thirteenth metal layer of the inductor circuitry 100. For example, the layer of the inductor coil 102 included in the second example 300 is disposed above the layer of the inductor coil 102 included in the first example 200 within the inductor circuitry 100.

In one example, the first turn 104 includes an aperture 302 (e.g., an M13 cut) and the second turn 106 includes an aperture 304 (e.g., an M13 cut). Notably, the aperture 302 may or may not extend into layers of the inductor circuitry 100 that are above or below the M13 layer and the aperture 304 may or may not extend into layers of the inductor circuitry 100 which are above or below the M13 layer. Although the layer of the inductor coil 102 included in the second example 300 is described as an M13 layer, it is to be appreciated that the layer of the inductor coil 102 included in the second example 300 is capable of being implemented as various layers of the inductor circuitry 100 such as an M11 layer, an M12 layer, an M14 layer, an M15 layer, and so forth.

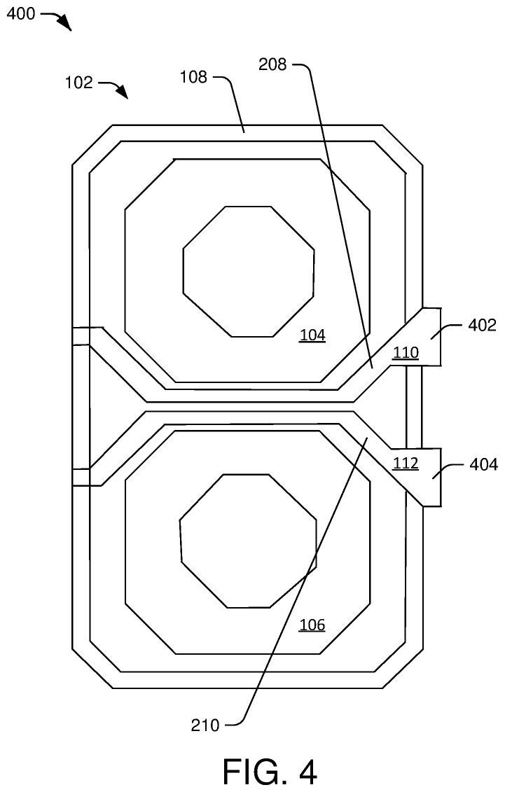

FIG. 4 depicts a diagram 400 illustrating an isolation wall 108 of inductor circuitry 100, according to an example. In an embodiment, the isolation wall 108 is disposed around the first turn 104 and the second turn 106 of the inductor coil 102 in a manner which is configured to provide a predetermined return path for current within the inductor circuitry 100 which stabilizes inductance values within the inductor circuitry 100. In some examples, the isolation wall 108 is not physically connected to the first turn 104 or the second turn 106 of the inductor coil 102. For example, the isolation wall 108 extends below and above the inductor coil 102 within the inductor circuitry 100. In one example, the isolation wall 108 is fabricated using all layers of the inductor circuitry 100 (e.g., full layer deck) and extends from an oxide diffusion (OD) layer to a top metal layer of the inductor circuitry 100. By disposing the isolation wall 108 around the first turn 104 and the second turn 106 in this manner, the isolation wall 108 effectively prevents modulation from a power grid and surrounding circuits while simultaneously suppressing coupling from neighboring/adjacent circuits.

In an example, the isolation wall 108 is disposed around the first portion 208 of the first inductor leg 110 and the second portion 210 of the second inductor leg 112. In this example, the isolation wall 108 Includes one or more apertures (e.g., the first aperture 114 and the second aperture 116) that are configured to enable an external portion 402 of the first inductor leg 110 and an external portion 404 of the second inductor leg 112 to extend out from the isolation wall 108. For instance, the external portion 402 and the external portion 404 are not disposed within (inside of) the isolation wall 108.

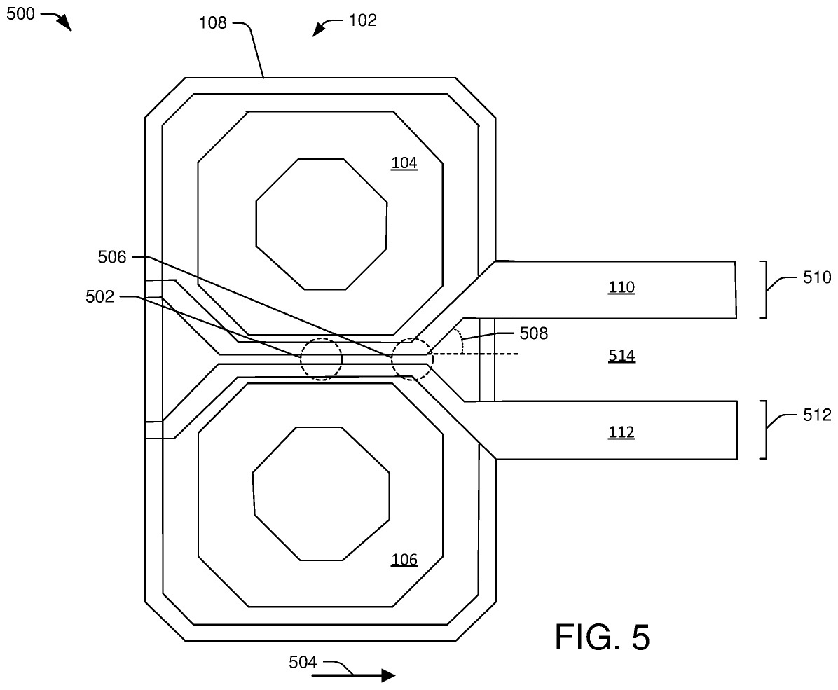

FIG. 5 depicts a diagram 500 illustrating inductor legs of inductor circuitry 100, according to an example. As shown in FIG. 5, the diagram 500 illustrates the first inductor leg 110 and the second inductor leg 112. In some embodiments, the first inductor leg 110 and the second inductor leg 112 originate from a first reference location 502 which is disposed between the first turn 104 and the second turn 106. In these embodiments, the first inductor leg 110 and the second inductor leg 112 extend laterally from each side of the first reference location 502.

In an example, lateral extensions of the first inductor leg 110 and the second inductor leg 112 extend away from the first reference location 502 in a horizontal direction 504 and eventually terminate this extension away from the first reference location 502 in the horizontal direction 504 at a second reference location 506. For example, at the second reference location 506, the first inductor leg 110 begins to extend away from the second reference location 506 at an acute angle 508 in a first direction and the second inductor leg 112 begins to extend away from the second reference location 506 at the acute angle 508 in a second direction. In this example, a width of the first inductor leg 110 increases between the second reference location 506 and the isolation wall 108 and a width of the second inductor leg 112 also increases between the second reference location 506 and the isolation wall 108. For instance, increasing the width of the first inductor leg 110 and the width of the second inductor leg 112 increases cross-sectional areas of portions of the first inductor leg 110 and the second inductor leg 112 having the increased width which reduces current crowding though the portions of the first inductor leg 110 and the second inductor leg 112 having the increased width, improves heat dissipation within the portions of the first inductor leg 110 and the second inductor leg 112 having the increased width, etc.

In an embodiment, at the isolation wall 108, the first inductor leg 110 begins to extend away from the isolation wall 108 in the horizontal direction 504 having a maximum width 510 and the second inductor leg 112 begins to extend away from the isolation wall 108 in the horizontal direction 504 having a maximum width 512. For instance, the maximum width 510 and the maximum width 512 are configured in accordance with a maximum design rule to mitigate/minimize parasitic resistance which depends on trace width, resistance targets, routing constraints, electromitigation considerations, etc. In some embodiments, a center of the first inductor leg 110 and a center of the second inductor leg 112 are disposed above a center 514 of the capacitor array 120 (and/or the bus lines 118 of the capacitor array 120) in order to efficiently direct current flow (e.g., through the two most efficient paths-the first inductor leg 110 and the second inductor leg 112). In these embodiments, orienting the center of the first inductor leg 110 and the center of the second inductor leg 112 relative to the center 514 of capacitor array 120 (and/or the bus lines 118 of the capacitor array 120) in this manner further improves performance of the corresponding LC tank within the inductor circuitry 100 by increasing routing efficiency (e.g., directing the current flow).

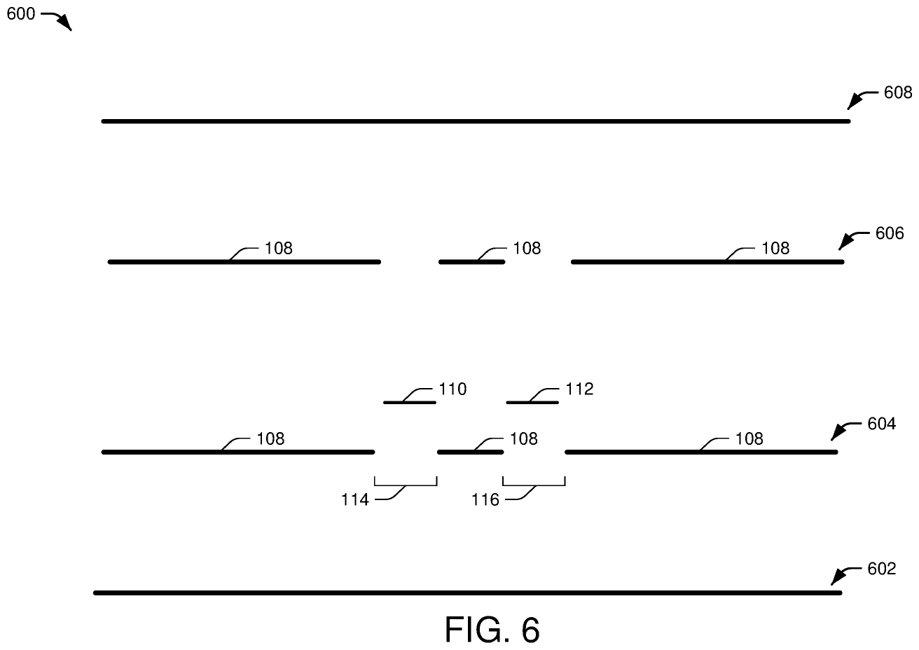

FIG. 6 illustrates a representation 600 of example layers of inductor circuitry 100, according to an example. The representation 600 includes layers 602-608 of the inductor circuitry 100. In an example, layer 602 is an OD layer of the inductor circuitry 100, an M0 layer of the inductor circuitry 100, etc. In some embodiments, layer 608 is a top metal layer of the inductor circuitry 100. In the representation 600, layer 604 and layer 606 are illustrated as layers of the isolation wall 108. For example, the layer 604 includes at least a portion of the first aperture 114 which the first inductor leg 110 extends through to form a portion of the LC tank circuit. In another example, the layer 604 includes at least a portion of the second aperture 116 which the second inductor leg 112 extends through to form another portion of the LC tank circuit.

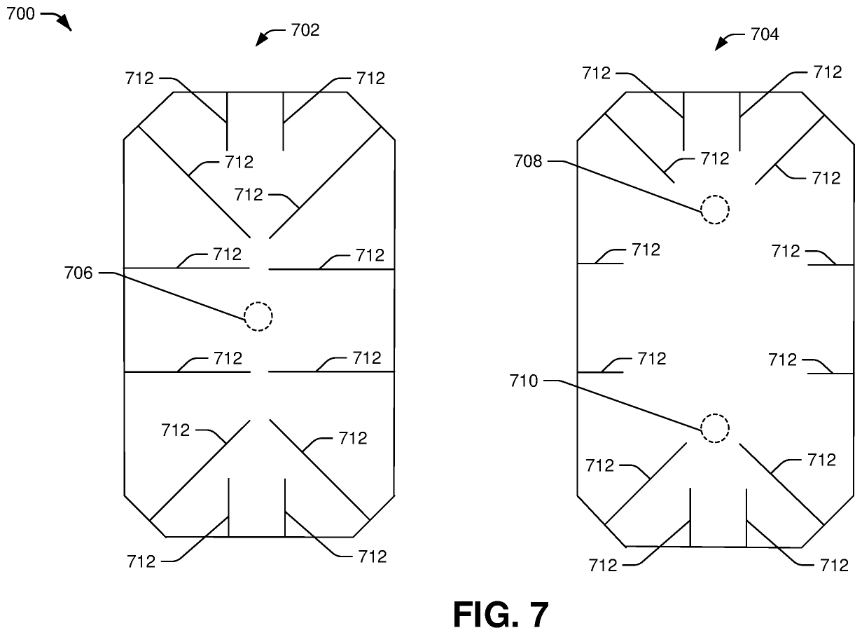

FIG. 7 illustrates a representation 700 of a first pattern ground shielding (PGS) design 702 and a second PGS design 704, according to an example. In various embodiments, the first PGS design 702 and the second PGS design 704 achieve similar performance characteristics and are implementable using a lower metal layer (e.g., an M0 layer) of the inductor circuitry 100. For instance, both the first PGS design 702 and the second PGS design 704 are configured to suppress noise within the inductor circuitry 100, minimize interference by or with the inductor circuitry 100, and/or improve overall operation of the inductor circuitry 100 by electrically shielding the inductor coil 102.

In one embodiment, the first PGS design 702 includes a termination hole 706 (e.g., a single termination hole) disposed between the first turn 104 and the second turn 106. For example, the termination hole 706 is configured to provide access to a ground connection (e.g., a ground plane, a ground grid, etc.) In another embodiment, the second PGS design 704 includes a first termination hole 708 which is disposed within the first turn 104 and a second termination hole 710 which is disposed within the second tum 106. Like the termination hole 706, the first termination hole 708 and the second termination hole 708 are configured to provide access to a ground connection such as a ground plane or a ground grid.

Notably, both the first PGS design 702 and the second PGS design 704 include multiple electrical conductors 712. For example, the electrical conductors 712 are wires, lines, elongate geometries formed using electrically conductive materials, etc. When the electrical conductors 712 are oriented in directions which are perpendicular to directions of current flow through the inductor coil 102, the electrical conductors 712 are capable of shielding the first turn 104 and the second turn 106 from electrical interference. In some examples, in order to ensure that the electrical conductors 712 of the first PGS design 702 and the second PGS design 704 are perpendicular to directions of current flow within the inductor coil 102 (e.g., the helically shaped coil), horizontal “fingers” of the first PGS design 702 and the second PGS design 704 are folded or bent inwardly at about a 45 degree angle, and then used as connecting points.

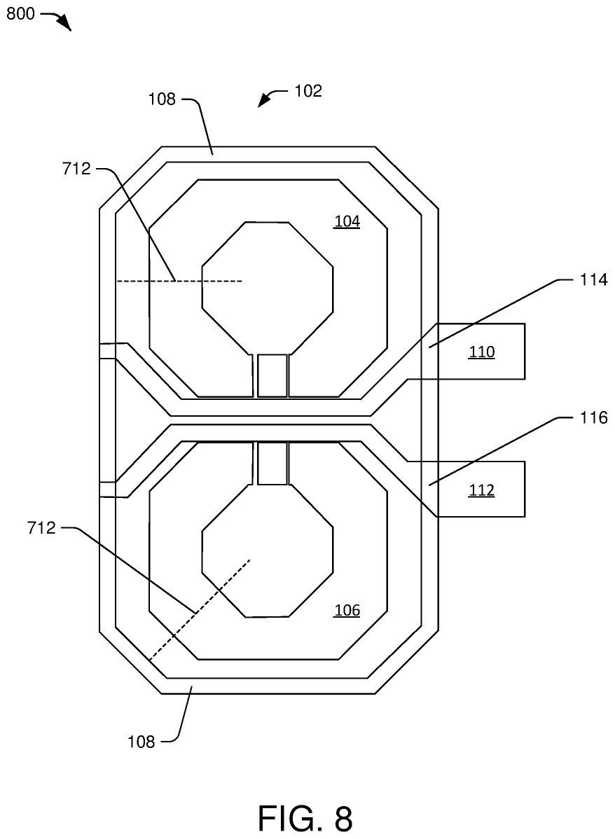

FIG. 8 depicts a diagram illustrating a differential inductor 800, according to an example. The differential inductor 800 is illustrated as including the inductor coil 102, the isolation wall 108 which extends above and below the inductor coil 102, the first inductor leg 110 which extends through the first aperture 114 in the inductor wall 108, the second inductor leg 112 which extends through the second aperture 116 in the inductor wall 108, and a PGS which is disposed below the inductor coil 102. For example, the PGS of the differential inductor 800 can be the first PGS design 702, the second PGS design 704, or another PGS design. Examples of the electrical conductors 712 are illustrated which are oriented perpendicularly to a direction of current flow through the first turn 104 and the second turn 106. Although two of the electrical conductors 712 are illustrated in FIG. 8, it is to be appreciated that, in various embodiments, the PGS of the differential inductor 800 includes many additional electrical conductors 712 which are oriented in directions that are perpendicular to directions of current flow through the inductor coil 102.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

While the foregoing is directed to specific examples, other and further examples may be devised without departing from the basic scope thereof, and the scope thereof is determined by the claims that follow.

What is claimed is:

1. Inductor circuitry comprising:
an inductor coil having a helical shape;
a first turn and a second turn of the inductor coil;
an isolation wall disposed around the first turn and the second turn, the isolation wall extending above the inductor coil and below the inductor coil; and
an inductor leg having a first portion disposed within the isolation wall, a second portion disposed outside of the isolation wall, and a third portion extending through an aperture in the isolation wall.

2. The inductor circuitry of claim 1, further comprising an area of partially overlapping layers of the inductor coil disposed between the first turn and the second turn, the area of the partially overlapping layers configured to connect the first turn and the second turn in series.

3. The inductor circuitry of claim 1, wherein the inductor leg has a variable width.

4. The inductor circuitry of claim 3, wherein the second portion has a greater width than the first portion.

5. The inductor circuitry of claim 1, wherein the second portion is configured to align with bus lines of a capacitor array.

6. The inductor circuitry of claim 1, further comprising a pattern ground shielding (PGS) disposed below the inductor coil.

7. The inductor circuitry of claim 6, wherein the PGS includes electrical conductors oriented perpendicular to a direction of current flow through the inductor coil.

8. The inductor circuitry of claim 6, wherein the PGS includes a termination hole disposed between the first turn and the second turn, the termination hole configured to provide access to at least one of a ground plane or a ground grid.

9. The inductor circuitry of claim 6, wherein the PGS includes a first termination hole disposed within the first turn and a second termination hole disposed within the second turn, the first termination hole and the second termination hole configured to provide access to at least one of a ground plane or a ground grid.

10. The inductor circuitry of claim 1, wherein the isolation wall is configured to physically isolate the first turn and the second turn from a capacitor array.

11. A differential inductor comprising:
a helically shaped coil;
an upper turn of the helically shaped coil;
a lower turn of the helically shaped coil;
an isolation wall disposed around the upper turn and the lower turn, the isolation wall extending above and below the upper turn and the lower turn;
an upper inductor leg extending through a first aperture in the isolation wall, the upper inductor leg including an upper medial portion disposed within the isolation wall and an upper lateral portion disposed outside of the isolation wall; and
a lower inductor leg extending through a second aperture in the isolation wall, the lower inductor leg including a lower medial portion disposed within the isolation wall and a lower lateral portion disposed outside of the isolation wall.

12. The differential inductor of claim 11, further comprising a pattern ground shielding (PGS) disposed below the upper turn and the lower turn.

13. The differential inductor of claim 12, wherein the PGS includes electrically conductive lines oriented perpendicularly to a direction of current flow through the helically shaped coil.

14. The differential inductor of claim 12, wherein the PGS includes a termination hole disposed between the upper turn and the lower turn, the termination hole configured to provide access to at least one of a ground plane or a ground grid.

15. The differential inductor of claim 12, wherein the PGS includes a first termination hole disposed within the upper turn and a second termination hole disposed within the lower turn, the first termination hole and the second termination hole configured to provide access to at least one of a ground plane or a ground grid.

16. The differential inductor of claim 11, wherein the upper medial portion and the lower medial portion are configured to align with bus lines of a capacitor array.

17. An integrated circuit (IC) device comprising:
an inductor coil having a helical shape;
an isolation wall disposed around the inductor coil, the isolation wall extending above the inductor coil and below the inductor coil;
a first inductor leg configured to align with bus lines of a capacitor array, the first inductor leg extending from within the isolation wall and through a first aperture in the isolation wall;
a second inductor leg configured to align with the bus lines, the second inductor leg extending from within the isolation wall and through a second aperture in the isolation wall; and
a pattern ground shielding (PGS) disposed below the inductor coil, the PGS having electrical conductors oriented perpendicular to a direction of current flow through the inductor coil.

18. The IC device of claim 17, further comprising an area of partially overlapping layers of the inductor coil disposed between a first turn of the inductor coil and a second turn of the inductor coil, the area of the partially overlapping layers configured to connect the first turn and the second turn in series.

19. The IC device of claim 18, wherein the PGS includes a first termination hole disposed within the first turn and a second termination hole disposed within the second turn, the first termination hole and the second termination hole configured to provide access to at least one of a ground plane or a ground grid.

20. The IC device of claim 18, wherein the PGS includes a termination hole disposed between the first turn and the second turn, the termination hole configured to provide access to at least one of a ground plane or a ground grid.
